(19) United States
(12) Patent Application Publication
(10) Pub. No.: US 2010/0257081 A1
(43) Pub. Date: Oct. 7, 2010

(54) CUSTOMIZABLE PAYMENT AND METHOD

(75) Inventor: Brian L. RITCHIE, Jacksonville, FL (US)

Correspondence Address: HOGAN LOVELLS US LLP;IP GROUP, COLUMBIA SQUARE, 555 THIRTEENTH STREET, N.W., WASHINGTON, DC, 20004, US

(73) Assignee: Payformance Corporation, Jacksonville, FL (US)

(21) Appl. No.: 12/816,896

(22) Filed: Jun. 16, 2010

Related U.S. Application Data
(63) Continuation of application No. 11/352,407, filed on Feb. 13, 2006.
(60) Provisional application No. 60/651,626, filed on Feb. 11, 2005.

(51) Int. Cl. G06Q 20/00; G06Q 10/00; G06Q 30/00; G06Q 50/00; G06F 15/16

(52) U.S. Cl. 705/34; 705/44; 705/30; 709/206

(57) ABSTRACT

The invention provides a system and method for facilitating secure payments to a payee. In accordance with the invention, a payee can enroll and/or register with a customized account processing center (CAPC). The CAPC can include payment information about the payee, such as the payee's account number and the payee's preferred payment format. When a payee is registered and elects payment via electronic funds transfer, the CAPC issues instructions to the bank to transfer funds from the payer's bank account to the payee's bank account which may be at the same bank or at a different bank. The CAPC can also create a detailed record of payment histories which are accessible to the payee. The CAPC also can send a notification to the payee when a payment is made.

### CROSS REFERENCE TO RELATED APPLICATION

This application claims priority under 35 U.S.C. 119(e) to U.S. Provisional Application No. 60/651,626 filed on Feb. 11, 2005, the disclosure of which is incorporated herein by reference.

### FIELD OF THE INVENTION

The invention relates to a system and method for electronic payment, and more particularly for a system and method that facilitates centralized payments and payment decisioning through third a party.

### DESCRIPTION OF RELATED ART

Conventional systems and methods for billing and payment are generally paper intensive whereby bills are printed on paper and payment is made by a paper instrument, such as a check. These conventional methods for billing and payment are not optimal for several reasons, including, the excessive time that may be required for delivering and processing physical documents, as well as overhead costs involved with delivering physical documents, such as the cost of postage or a private delivery service and the personnel necessary to administer the handling of such documents. These conventional billing and payment methods are also cumbersome due to the need for complex record keeping and the need to store large quantities of paper records. The difficulties in maintaining proper record keeping and accounting are further exacerbated for those business entities that process large amounts of billing (such as invoices) and payments (such as checks) from numerous and diverse entities.

The incorporation of electronic systems and methods for the dissemination and collection of invoices and payments has become increasingly common over the last several years. Initially, such electronic transfers existed primarily between banks, with the introduction of electronic funds transfers through systems such as the automated clearing house. More recently, non-banking entities, including individual consumers, are increasingly taking advantage of the increased efficiencies of electronic payment systems.

The payment methods associated with the health care industry have additional nuances that are specific to that industry. A hospital or other health care provider (such as a doctor, clinic, or laboratory technician) typically may bill a patient's insurance company at a list price for the services rendered to a patient. If the patient is insured, the insurance company will determine the price contracted for that particular service that will be paid to the health care provider based upon the terms of the patient's insurance plan and/or the terms of existing agreements between the insurance company and the health care provider. The insurance company will then issue payment, typically a paper check, to the health care provider along with an explanation of payment (EOP). The EOP may explain the basis for the amount of payment made to the health care provider. The health care provider does not usually receive full payment of the list price and will often have to write-off the amount of the underpayment. However, because of the delay that often results between the sending of invoices from the health care provider to the insurance company, the processing of invoices at the insurance company and the sending of payment from the insurance company to the health care provider, these write-offs often occur later in time which may delay the posting of the payment on the provider's books, thus interfering with prompt accounting. More importantly, health care providers typically must submit invoices to a myriad of insurance companies (given that the different patients they serve are often enrolled with various insurance companies). Because insurance companies may employ differing formats for the explanation of payments that may accompany payment, health care providers have an additional administrative burden. Thus, the conventional billing and payment methodologies can be even more burdensome in certain industries, such as the health care industry.

### SUMMARY OF THE INVENTION

The present invention provides system and method for business entities (including health care entities) to efficiently disburse, manage, record or disseminate, payments, payment information, and associated information. Although reference is made to business entities, the present invention is equally applicable to non-profit or government institutions, or any entities in which financial obligations are incurred or financial receivables are obtained.

Business entities typically have prior, current, and potential (future) obligations as well as previous, current and potential (future) receivables (amounts owed, owing, or to be owed by other entities to the business entity). To handle the transfer, disbursement and dissemination of billing information (including invoices), payments, payment information, and associated information, the invention provides a customized account processing center (CAPC).

In accordance with the invention, a business entity may register with the CAPC in order to establish particular customized procedures and practices by which the CAPC will facilitate payments by the business entity to various payees. Thus, the CAPC acts as an agent for the payer in order to facilitate payment. These procedures and practices will typically be contained as terms in a customized account processing agreement executed between the business entity and the CAPC. If the CAPC is facilitating payments by the business entity to a payee, the agreement may include terms limiting the maximum disbursement that may be made by the CAPC in any one payment, the cumulative maximum payments the CAPC may authorize over a given period of time, the record keeping or accounting obligations of the CAPC, the circumstances under which the CAPC is authorized to make payments, including the method for authenticating the business entity's authorization for payment, and the disclosure of the financial structure and relationship between the business entity and CAPC (the account numbers to be used by CAPC in making payments). When the CAPC is facilitating payment to a payee, the terms of the customized account processing agreement may include terms directing the disposition of payments received (such as automatic electronic fund transfers to particular accounts or the crediting of accounts held by CAPC—either internally within CAPC or externally with other entities—for payments received by the CAPC on behalf of the business entity as payee), the handling and formatting of payment information, and the handling and formatting of associated information, including such information required to facilitate payments. The terms of the customized account processing agreement and the customized functions performed by the CAPC will typically be based upon the particular requirements, strategies and structure of the business entity.

One feature of the present invention is the delivery of a custom-formatted payment, custom-formatted payment information and custom-formatted associated information to business entities (which may be acting in capacities as either payees or payers, or both payees and payers).

Payment may refer to the transfer of value from one entity to another and may be done by numerous methods such as checks, cash, electronic fund transfers, the crediting of internal or external accounts held by any entity. Payment information may include information identifying the payer, payee, amount of payment, date for payment, and the like. Associated information may include miscellaneous information regarding the reasons for a particular amount of payment (in the case of health care industry, for example, this may be an explanation of payment), comments, suggestions, complaints, or any other information deemed appropriate by a party with whom the associated information is concerned.

In accordance with one embodiment of the invention, the CAPC handles payment to payees for the business entity (when the business entity would normally be acting in the capacity of a payer). In accordance with the invention, a business entity may provide to the CAPC payment information, its own account information and authorization across a secure communication channel. Although this secure communication channel may be a dedicated communication channel between the business entity and the CAPC, it is generally more cost effective and convenient for such information to be securely exchanged over public networks using trust-worthy encryption techniques, which are commonly available on the open market and may be readily purchased. Once the CAPC receives the payment information and authorization from the business entity, the CAPC may act in accordance with a customized account processing agreement that was entered into between the business entity and the CAPC. This agreement may direct how the payee is to receive the funds. If the payee is registered with the CAPC, the CAPC will act in accordance with an customized account processing agreement entered into between the payee and the CAPC. Thus, the CAPC facilitates payment to the payee by accessing the business entities (payer's) account to transfer payment to the payee in the form of a check or by electronic payment.

In accordance with an embodiment of the invention, in the instances where the payee is not enrolled and/or registered with the CAPC, the payment may take the form of a physical check which may be printed and mailed by the CAPC to the payee. The invention also provides that the CAPC may direct an invitation to the payee to register with the CAPC. The invitation may include a link to a secure website for registering with the CAPC. The invitation may notify the payee that he or she may register with the CAPC so that future payments can be made electronically and can be made by the CAPC in a custom-format to the payee's specification (such as immediate deposit into particular accounts). Additionally, the payee may be informed that registration with the CAPC will allow the custom-formatting of associated information that may accompany payment. Given that the associated information may come in different formats from different payers (such as insurance companies' use of different formats for the explanation of payment), custom-formatting performed by the CAPC on behalf of the payee may further simplify the administrative handling of the payment collection, including accounting and record keeping.

As described above, one approach for informing the payee of the beneficial services offered by the CAPC is to provide the unenrolled/unregistered payee with such information in a separate mailing, telephone solicitation or electronic message to the payee (although telephone solicitation may be restricted by applicable laws, it is notable that there is an existing business nexus between the CAPC and the payee, as the payment made to and presumably accepted by the payee originates from the CAPC). This has the beneficial effect of informing the payee of the availability of the CAPC's services through a trustworthy manner as the invitation is directed by the CAPC or a third party authorized by the CAPC. Moreover, this method is particularly well-suited and may be preferred over other advertising methods as it is directed targeted to only those parties who are eligible to use the services offered by a CAPC.

In accordance with an embodiment of the invention, the method by which the payee is invited to register may be facilitated by the inclusion of a reserved registration code that the CAPC associates with the payee. The payee may utilize this registration code to register with the CAPC via the Internet (most likely through a secure website), by telephone, by mail, or by any other practicable means.

Payees may receive payments from multiple payers, with each payer potentially using a different format for the delivery of payment, payment information, and associated information. The system in accordance with the invention allows convergence of these different sources and formats of payment, as well as the different sources and formats of associated information into a consistent format with easily accessible record keeping and a centralized source for the presentation of information regarding payments. The invention allows payees to increase their operating efficiency through to standardization of the myriad of information and payments into a uniform format best suited to its own operations.

Although as used herein, a payer typically has a financial obligation to a payee and makes payment to the payee, it is easily foreseeable that parties may be mutually obligated and that parties may simultaneously be deemed a payer and a payee.

In accordance with the invention, payees may register or enroll with the CAPC through their own initiative and payees may enroll at the behest of a payer with whom the payees interacts. Thus, payers may take advantage of the present invention regardless of whether any payees are registered with the CAPC. If the payee is not registered with the CAPC, a paper check is issued in the same fashion as payments are typically issued.

Thus, the invention provides a centralized payment processing system that allows multiple payees and payers to join. The system in accordance with the invention verifies that the payees and payers are the proper parties to the payment transaction in order to prevent errors and/or fraudulent transactions. The system in accordance with the invention also creates a record of payments and related information that is viewable by payees. This allows payees to verify and reconcile received payments against outstanding invoices, resulting in fewer misapplications of payments to their related invoices. The system in accordance with the invention also provides for electronic notification to payees of payments received. The system in accordance with the invention also facilitates payments to payees not enrolled in the centralized payments processing system and notifies them of the opportunity to enroll in the system.

Depending on particular configuration of the embodiment of the present invention, benefits that may be achieved in embodiments of the present invention include:
More rapid disbursement of payments;
Customized delivery of payments and associated information;
Simplified accounting, record keeping, and management of payment;
Increased cost efficiency by reducing administrative and operating costs;
Improved fraud detection and decrease in processing errors by the creation of more uniform information presentation and handling;
A more secure and consistent method of payment by elimination of distribution through the postal or other mail or package delivery service;
Confirmation to payees of payments received by electronic means or other reliable methodologies;
Batch enrollment of multiple payees and payers within a common payment system;
Archiving of all payment histories, the archives being viewable by payees; and
Verification that payees and payers are the proper parties.

### BRIEF DESCRIPTION OF THE DRAWINGS

FIG. 1 shows a block diagram of an embodiment of the invention illustrating the payer, a payee and a customized account processing center for facilitating payments;

FIG. 2 shows a block diagram of the system illustrated in FIG. 1 described in terms of the health care industry; and

FIG. 3 is a flowchart illustrating a process for facilitating payments utilizing the customized account processing center in accordance with the invention.

### DETAILED DESCRIPTION OF THE PREFERRED EMBODIMENTS

The invention disclosed herein may be beneficially applied to diverse business entities across numerous service and manufacturing industries such as the health care industry, the automotive industry, the food services industry, or any other manufacturing or service industries, such as the financial institutions associated with the payment process (including banks, credit unions, brokerages and insurance companies).

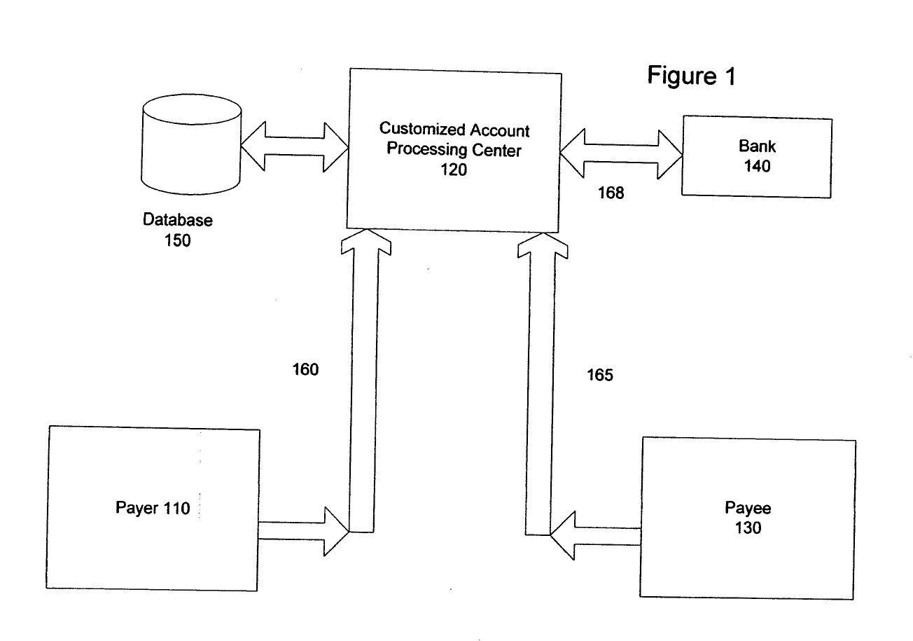

One embodiment of the invention is depicted in FIG. 1, FIG. 1 shows a payer 110 in communication via a link 160 with a customized account processing center (CAPC) 120. FIG. 1 also shows a bank or other financial institution 140 in communication via the link 168 with the CAPC 120. FIG. 1 also shows a payee 130 in communication via the link 165 with the CAPC 120. FIG. 1 also shows a database 150 which is accessible and communicatively coupled to the CAPC 120. It should be noted that the communication links 160, 165 and 168 can be any of a number of types communication channels, such as a local area network (LAN), a virtual private network (VPN) or the Internet. The database 150 is capable of storing a variety of information relating to payers and/or payees, such as account information, payment rules and formats, etc. In general, the system illustrated in FIG. 1 allows a plurality of payers to facilitate payments to a plurality of payees. As will be described in greater detail below, individual payees can enroll with the CAPC 120. By enrolling with the CAPC 120, the payee 130 is part of the CAPC 120 and can view archived records of payment histories. Thus, the payee 130 can review when payments were received and can take corrective action if there is a payment problem. Once enrolled, the payee 130 also has the option of registering with the CAPC 120. When the payee 130 registers with the CAPC 120, he or she can provide the CAPC 120 with their account number so that transactions can be made electronically. This also allows the payee 130 to view their account electronically. The payee 130 also receives an electronic notice from the CAPC 120 when a payment has been made. This puts the payee 130 on alert that a payment has been made. Concurrently, the CAPC 120 issues instructions to the bank 140 to transfer funds to the back account of the payee 130. A registered payee also has the ability to import payment details from the CAPC 120 in a custom format as may be selected by the payee 130. This allows the payee 130 determine which invoices are being paid at a particular time by the payer and results in less unallocated funds. The system also allows payee to post back into its account so that it can confirm what it is being paid for. The CAPC 120 also has functionality to verify that both the payer 105 and the payee 130 are the proper parties.

In operation, when a payer 110 receives an invoice from a payee 130 for goods or services, it can review and assess the received invoice and make a decision as to whether payment should be made. If a decision to make payment is made, the decision can be conveyed to the CAPC 120. If the payer 110 is new to the CAPC 120, then that payer can register with the CAPC 120 and provide certain information, such as the payer's account information at the bank and other payment details, such as specific times when to make payment. If the payer is already registered with the CAPC 120, then various information about the payer 110 may be stored in the database 150 and the CAPC 120 authenticates the payer 110 to confirm that he or she is the registered payer. By having this information which can be accessed as needed, errors that arise when information is re-keyed do not occur. A decision to make payment may include the amount to be paid, the payer's account information, along with additional information to be conveyed with the payment, such as an explanation of the payment. Once the CAPC 120 has received authorization to make payment for a payer 110, it authenticates both the payer 110 and the payee 130 to confirm that they are the proper parties, i.e., that the payee is the correct party to receive payments and the payer is the correct party to make payments. Then payments are made using the payer account information that is stored in the database 150. If the payee 130 is not enrolled and registered with the CAPC 120, then payment made be made in the form of a paper instrument, such as a check. However, if the payee 130 is enrolled and registered with the CAPC 120, then payment may be made in accordance with any existing settings by communicating with the bank 140 and issuing the necessary instructions to transfer funds electronically. For example, the payee 130 may have instructed the CAPC 120 to make payment electronically to a particular account number. Alternatively, the payee 130 may desire a paper check. Payment by a paper check is also the default payment setting when the CAPC 120 does not have any pre-existing data about the payee 130. The CAPC 120 sends a notice to the all registered payees when a payment has been made. This notice may be an electronic notification, such as an e-mail message.

The CAPC 120 stores a variety of payment records/histories. The CAPC 120 stores the entire payment history and records for all payments made to the payee 130 for a predetermined amount of time set by the payee. In one embodiment of the invention, an extended archive may be created which records every transaction for a payee since its enrollment with the CAPC. This log includes information about when payment was made, how much payment was made and what the payment was for. Those payees who are enrolled with the CAPC 120 have the ability to view these records. The CAPC 120 also allows payees to manage their accounts. The CAPC 120 allows registered payees to import payment details in a standard format that can be selected by the payee. Thus, at any time, the payee 130 can determine why certain funds were received and what they are directed to. This minimizes unnecessary accounts receivables on the records of the payees as they quickly can match received funds with the invoices they are intended for. Payees can then write-off any excess charges that the payers will not pay for.

In one embodiment of the invention, when payment is made via the CAPC 120 to a payee 130 and the payment is made by a paper check or by other non-electronic means, the CAPC 120 may send a separate invitation for the payee 130 to enroll and/or register with the CAPC 120 so that future payments may be made electronically. Alternatively, the CAPC 120 can request a third party to send such an invitation to enroll directly to the payee 130 and also to provide the electronic notice of payment received. Registering with the CAPC 120 will also allow payees to establish particular guidelines and standards for receiving payment, such as dates and times when payment is preferred, for example and if they wish to be notified when a payment is received.

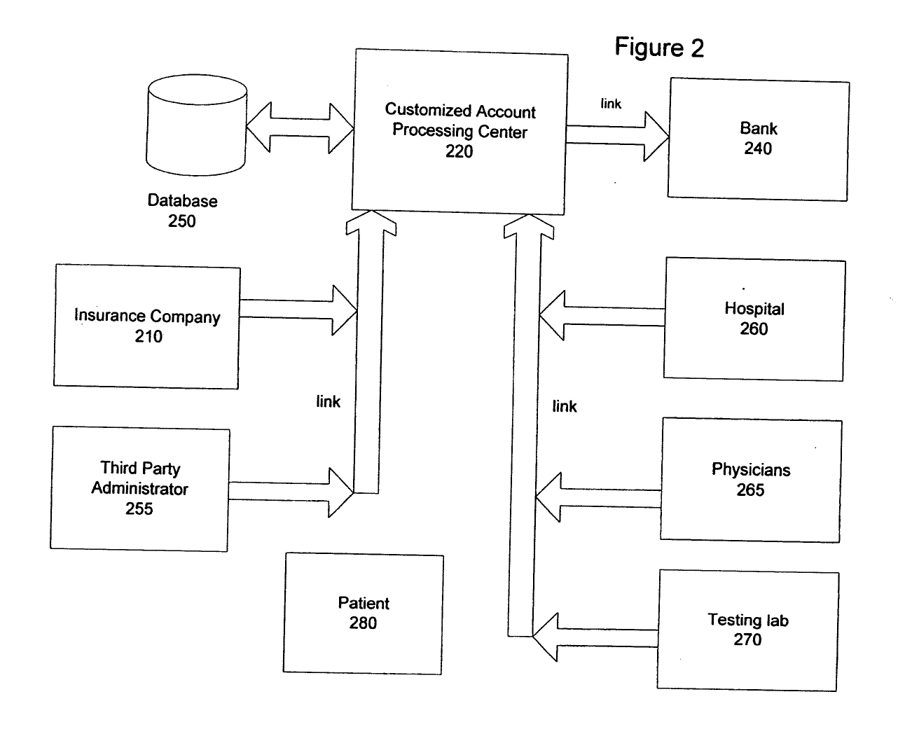

FIG. 2 describes the system in accordance with the invention in the context of the health care industry. FIG. 2 shows payers which include an insurance company 210 and a third administrator 255 that overseas a health plan, both of which act as payers and make payments for various health insurance claims. FIG. 2 also shows various health care providers, such as a hospital 260, group of physicians 265 and a testing lab 270 (collectively “health care providers” or “payees”). FIG. 2 also shows a bank or other financial institution 240 in communication with the CAPC 120. In this example, the health care providers 260, 265 and 270 deliver one or more services to a patient 280. The health care providers 260, 265 and 270 then generate an invoice for payment that is delivered to the insurance company 210 or their third party administrator 255. Upon receipt of the invoice, the payer's insurance company 210 or third party administrator will ascertain the nature of payment to be made to the payees. This will be based upon pre-negotiated rates between the insurance company 210 or third party administrator 255 and the health care providers 230. For example, although a hospital may bill $200 for an x-ray, the insurance company may have a pre-negotiated rate of $100 for such a service.

In accordance with the invention, the insurance company 210 and third party administrator 255 (“payers”) is registered with the CAPC 220 so that the CAPC 220 facilitates payments to the health care providers. The payees 210 and 255 can provide information about a variety of health care providers so that the CAPC 220 can facilitate payment to more than one health care provider. Upon determining the amount to be paid to the health care providers, the insurance company 210 or third party administrator 255 then notifies the CAPC 220 of the amount of payment to be directed to the health care providers. The CAPC 220 will determine whether the health care provider is enrolled and/or registered with the CAPC 220. If the health care provider is registered with the CAPC 220, then information relating to that health care provider, such as its account number as well as any other rules and conditions for making payment reside at the CAPC. The CAPC 220 then verifies that the payee and payer are then proper authorized parties and then payments can then be made to the health care providers. If the health care providers are known, such information will be stored in the CAPC's database 250. For registered users, the CAPC 220, can also access the terms and conditions for payment to the health care provider 230 and can make payment in accordance with those pre-existing terms and conditions. For example, the health care provider 230 may have instructions that payment must be made in paper form by check or alternatively electronically. If payment is to be made electronically, the CAPC 220 can issue instructions to the bank 240 to direct payment directly into that health care provider's bank account. If the health care provider is not enrolled or registered with the CAPC 220, then a paper payment, such as a check, is prepared and delivered to the health care provider. Those payees that are enrolled receive a notification, such as by electronic mail that payment has been received.

If the health care providers are enrolled with the CAPC 220, they will have access to the full payment histories and can view an archive of payments received. Registered health care providers can also import payment details from the CAPC 220 in a format that allows them to reconcile payments received with outstanding invoices.

In another embodiment of the present invention, the insurance company 210 or third party administrator 255 may be enrolled with the CAPC 220, while a particular health care provider to which the insurance company 220 or third party administrator 255 issues a payment is not enrolled. As invoices are submitted to the insurance company 210 by an unregistered health care provider and the corresponding payments are dispersed by the customized account processing center (after authorization from the insurance company), the customized account processing center may specifically and directly inform the unregistered health care provider (the payee) of the ability to register with the customized account processing center. This may be performed by providing a separate mailing, phone solicitation and/or e-mail notification on behalf of the insurance company 210 or third party administrator 255 to the health care provider. Thus, the system of the present invention can expand to include enrollees by specifically reaching them through a secure and direct approach.

Of course the embodiment above merely describes one sample embodiment of the invention within the health care industry of a small number of health care providers and a small number of insurance companies. It is expected that multiple health care providers and multiple insurance companies will advantageously use the present invention for their benefit. Indeed, a single patient may be associated with multiple insurance companies, thereby causing a health care provider to submit billing information to multiple insurance companies and subsequently receive multiple payments and multiple (often differing) explanation of benefits.

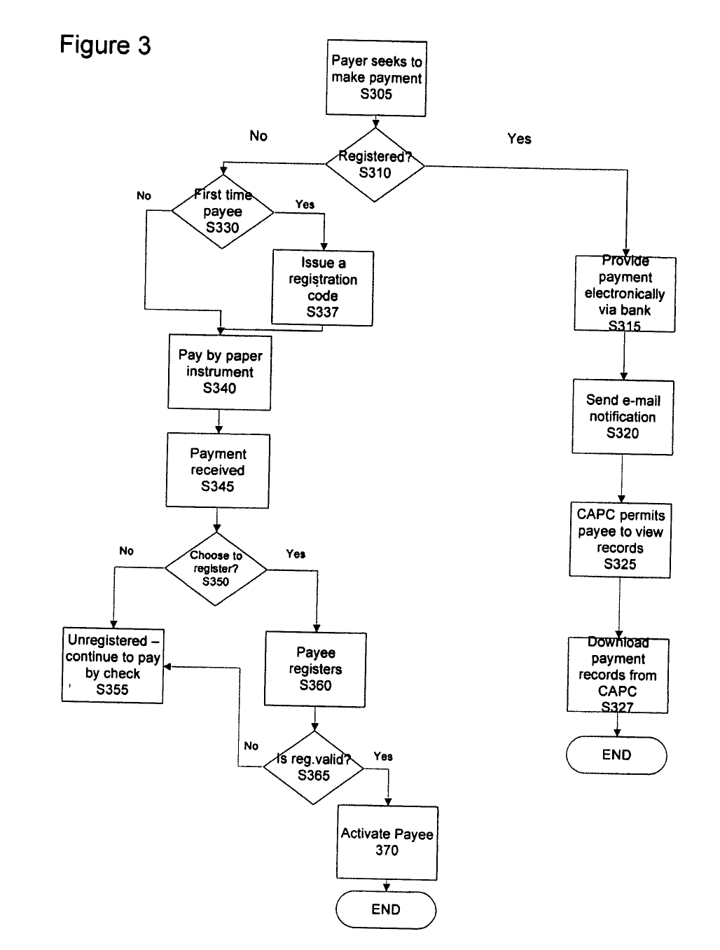

FIG. 3 shows a process flow for the operation of the CAPC in accordance with embodiments of the invention. FIG. 3 begins at step S305 in which a payer has determined that a amount of funds must be paid to a payee and submits authorization to the CAPC to make payment to a payee. If the payer is registered with the CAPC, the CAPC has prestored information about that payer, including his or her account number, as well as any other instructions regarding how payment should be made. The process then moves to step S310. In step S310, the CAPC determines whether the payee is enrolled and registered. If the payee is enrolled and registered, the process moves to step S315 where the CAPC provides payment to the payee in accordance with any instructions registered with the CAPC. These instructions may include when and where payment should be made, and whether such payments should be made electronically or by paper instrument such as a check. If payment is to be made electronically, account information is also registered with the CAPC. Thus, in step S315, payment is made in accordance with this pre-existing information. The process then moves to step S320 whereby a the CAPC sends a notification to the payee that a payment has been received. The process then moves to step S325. In step S325, the payee has access to view historical payment records and to also access information that will assist with reconciling the received payments with outstanding invoices. The process then goes to step S227 where the payee can download the payment history records. The process then ends.

Returning to step S310, if the payee is not registered with the CAPC, the process moves to step S330. In step S330, the CAPC determines whether the payee is a first time payee. If the payee not a first time payee, the process moves to step S340. If the payee is a first time payee, then the process moves to step S337 where the payee is issues a registration code and then the process moves to step S340. In step S340, the CAPC disburses the payment to the payee by a paper instrument, such as a check. As is described earlier, the CAPC may also separately send an invitation to register with the CAPC so that future payments may be made electronically. This invitation to register to the CAPC may include a link to a secure website for registering with the CAPC or other means for registering with the CAPC. The process then moves to step S345 where payment is now received by the payee and the payee also reviews the invitation to register with the CAPC. The process then moves to step S350 where the payee decides whether to register with the CAPC. If the payee decides to register with the CAPC, then the process moves to step S360; otherwise, the process moves to step S355. In step S355, where the payee has decided not to register with the CAPC, the payee will continue to receive checks or other paper payment instruments. Alternatively, in step S360 where the payee has decided to register with the CAPC, the payee then provides various information to the CAPC, such as account information and any other desired payment instructions and becomes registered. The process then moves to step S365 where the system determines whether the payee's registration code is valid. If the registration code is not valid, the process moves to step S355. If the registration code is valid, then the process moves to step S370 where the payee is activated and whereby future payments can be automated. The process then ends.

The foregoing description of the preferred embodiments of the invention has been presented for the purposes of illustration and description. It is not intended to be exhaustive or to limit the invention to the precise form disclosed. Many modifications and variations are possible in light of the above teaching.

What is claimed:

1. A method for facilitating automated and secure payment, comprising the steps of:
determining whether a payee is a registered entity;
accessing payment information for the payee upon a determination that the payee is a registered entity;
directing an automated payment to the payee based upon the payment information pre-determined payee and payer payment rules;
creating a record of payments to the payee that is accessible to the registered payee; and
sending the payee a notification that payment was made to the payee.

2. The method of claim 1, wherein the record of payments includes at least one of a record of each payment to the payee, an invoice number, a payment amount and a treatment code.

3. The method according to claim 1, wherein the record of payments is formatted in a standard requested by the payee.

4. The method according to claim 1, wherein the record of payments is accessible to the payee, allowing the payee to reconcile payments received with outstanding invoices.

5. The method according to claim 1, wherein the payment information includes at least one of a payee's account information, a payee's address and a payee's preferred payment format and method.

6. The method according to claim 1, wherein the notification in format requested by the payee.

7. The method according to claim 1, wherein the notification is at least one of an electronic mail notification, a telephone notification or a paper notification.

8. The method according to claim 1, including the step of authenticating the payee before the step of directing an automated payment to the payee.

9. The method according to claim 1, including the step of authenticating the payer before the step of directing an automated payment to the payee.

10. The method according to claim 1, wherein the payer can become a registered payee and wherein the registered payee provides at least one of payer account information, payer payments formats and payer payment rules.

11. The method according to claim 1, wherein payment is made to the payee by paper instrument upon a determination that the payee is unregistered.

12. The method according to claim 11, wherein the payee receives a solicitation for becoming a registered payee.

13. The method according to claim 1 wherein the payee is a health care provider and the payer is at least one of an insurance company, a third party administrator and another health care payer.

14. A system for automated and secure payment, comprising:
a customized account processing engine including a request for payment module, the request from payment module receiving at least one request for making payment to at least one payee;
a payment processing module for facilitating payment to the at least one payee based upon the at least one request for making payment, the payment processing module also sending a notification to the at least one payee upon payment; and
and a records module for creating a record of all payments to the at least one payee

15. The system according to claim 14, wherein the payment processing module determines whether the payee is a registered payee or an unregistered payee.

16. The system according to claim 14, wherein the payment processing module includes at least one of the payee's account information, the payee's address and the payee's preferred payment and payment rules.

17. The system according to claim 15, wherein the payment processing module makes payment to the payee by a paper instrument upon a determination that the payee is an unregistered payee.

18. The system according to claim 15, wherein the payment processing module makes an electronic payment to the payee upon a determination that the payee is a registered payee.

19. The system according to claim 14, wherein the notification includes an electronic mail message.

20. The system according to claim 14, wherein the records module includes payment details for all payers and payees, including at least one of payment amounts, date of payment, invoice numbers for which payment is being made, a payment amount and a payee treatment code.

21. The system according to claim 14, wherein the records module is accessible to the payee to facilitate confirmation of payment amounts and reconciliation of invoices.

22. The system according to claim 14, wherein the payer is an insurance company or other health care payer and the payee is a health care provider.

23. The method according to claim 14, wherein the customized account processing engine authenticates the payee before facilitating payment to the at least one payee.

24. The method according to claim 14, wherein the customized account processing engine authenticates the payer before facilitating payment to the at least one payee.
